(19) United States
(12) Patent Application Publication
(10) Pub. No.: US 2020/0260898 A1
(43) Pub. Date: Aug. 20, 2020

(54) AUTOMATIC JUICER APPARATUS AND METHOD

(71) Applicant: I-TECH USA, INC., Farmington Hills, MI (US)

(72) Inventor: Dong Un Kim, Northville, MI (US)

(21) Appl. No.: 16/795,755

(22) Filed: Feb. 20, 2020

Related U.S. Application Data
(60) Provisional application No. 62/808,128, filed on Feb. 20, 2019.
(60) Provisional application No. 62/932,893, filed on Nov. 8, 2019.

(51) Int. Cl. A47J 19/02; A23L 2/06

(52) U.S. Cl. CPC A47J 19/023; A23V 2002/00; A23L 2/06

(57) ABSTRACT

An automatic juicer apparatus includes a main body, a base, a motor, and a roller. The main body has a roller housing, an intake portion, a juice output portion, and a remains output portion. The intake portion is configured to maintain an object to be juiced, such as a cut half fruit, in a predetermined orientation. The roller is disposed in the roller housing of main body and is removably coupled to the motor. The roller is configured to rotate and press the object in the predetermined orientation against the roller housing to generate juice and to advance remains of the object to the remains output portion. The automatic juicer apparatus may also have a juice tray. The base supports the juice tray. The juice tray is configured to receive the juice from the juice output portion of the roller housing during a juicing operation.

### CROSS-REFERENCE TO RELATED APPLICATIONS

This application claims the benefit of U.S. Provisional Application Ser. No. 62/932,893, filed on Nov. 8, 2019, and U.S. Provisional Application Ser. No. 62/808,128, filed on Feb. 20, 2019. The entire disclosures of the above applications are hereby incorporated herein by reference.

### FIELD

The present disclosure relates to juicers and, more particularly, to an apparatus and method for automatically juicing fruits such as oranges and limes.

### BACKGROUND

Many people enjoy drinking juices such as citrus juices in the morning with breakfast. Moreover, it is widely known that freshly prepared or “fresh squeezed” juices taste the best and provide the most nutrients.

To make the preparation of “fresh squeezed” juices easier, a variety of knives and juicers have been developed. In preparation for juicing, the fruit is generally cut in half using a sharp knife, for example, to create a half fruit. The half fruit is then processed on one of a variety of known juicers to extract the juice, and generally some pulp.

Known juicers include stationary manual juicers such as reamers and manual citrus presses. With reamers, the reamer is placed on the center of a bowl for an operator to push down and twist a half fruit. The juice is then caught in the bowl. With manual citrus presses, a half citrus fruit is placed on a reamer and a lever is manually pulled down to squeeze the fruit on the reamer. The juice is then caught in a bowl or funnel and directed to a container for storage.

Other known juicers also include electric juicers, where a half fruit is placed on a reamer that spins using an electric motor. This extracts the juice from the fruit and directs it into a glass or other container.

However, manual citrus presses and electric juicers are generally large and take up valuable space in kitchen cabinets. These conventional devices also require a fair amount of cleaning after use. They can further be awkward to operate. Therefore, these known juicing devices are not well suited to a small kitchen or to limited uses, where a single citrus fruit is being juiced for a small serving or where only a small amount of juice is needed.

There is a continuing need for a juicer that is suitable for consumer household use. Desirably, the automatic juicer has removable parts to facilitate cleaning.

### SUMMARY

In concordance with the instant disclosure, a juicer that is suitable for consumer household use, and which has removable parts to facilitate cleaning, is surprisingly discovered.

In one embodiment, an automatic juicer apparatus includes a main body, a base, a motor, and a roller. The main body has a roller housing, an intake portion, a juice output portion, and a remains output portion. The intake portion is configured to maintain an object to be juiced, such as a cut half fruit, in a predetermined orientation. The main body is removably disposed on the base. The base is configured to support the main body on a surface such as a table or countertop in a home. The motor is disposed in the base. The roller is disposed in the roller housing of main body and removably coupled to the motor. The roller is configured to rotate and press the object in the predetermined orientation against the roller housing to generate juice and to advance remains of the object to the remains output portion. The automatic juicer apparatus may also have a juice tray. The juice tray is disposed between the juice output portion of the main body and the base. The base supporting the juice tray. The juice tray is configured to receive the juice from the juice output portion of the roller housing during a juicing operation.

In another embodiment, the automatic juicer apparatus may further include a receiving portion and a cover portion. The receiving portion is removably coupled with the intake portion of the main body. The receiving portion is also configured to orient the half fruit into the predetermined orientation for juicing. The cover portion is removably disposed on the receiving portion. The cover portion may have a hole formed therethrough. The automatic juicer apparatus may in additional have a pusher. The pusher is adapted to manually position the half fruit to be juiced into the roller housing through the intake portion of the main body. The pusher is received by the hole in the cover portion of the receiving portion. The automatic juicer apparatus may also have a coarse grate and a fine grate. The coarse grate and the fine grate are removably disposed between the juice output portion of the roller housing and the juice tray. The coarse grate is disposed adjacent to the juice output portion of the roller housing. The fine grate is disposed adjacent to the juice tray.

In a further embodiment, a method for juicing includes a first step of providing the automatic juicer apparatus as described. In a second step, the object to be juiced is cut to form a half object. The half object has an uncut surface and a cut surface. In a third step, the half object is fed through the intake portion of the automatic juicer apparatus such the cut surface of the half object faces away from the roller and the uncut surface abuts the roller. In a fourth step, the roller is rotated by the motor to cause the half object to be pressed against the roller housing of the main body. Juice is thereby generated from the half object. The rotating of the roller also causes remains of the half object to be advanced to the remains output portion of the main body for disposal. In an optional fifth step, the juice may be filtered as it flows from the juice output portion of the roller housing to the juice tray, for example, by the at least one grate. In a sixth step, the juice is collected, by way of the juice tray. The juice flows through the juice output portion of the roller housing to the juice tray.

In a most particular embodiment, an operator uses the automatic juicer apparatus by cutting an object, such as a piece of fruit, such that it has a cut side and an outer side. The operator feeds the fruit through the intake portion. The roller presses juice between the main body of the automatic juicer apparatus and the roller and juice collected then exits the main body. The operator can orientate the fruit such that the cut side is adjacent the main body and the outer side is adjacent the roller.

### DRAWINGS

The above, as well as other advantages of the present disclosure, will become readily apparent to those skilled in the art from the following detailed description, particularly when considered in the light of the drawings described hereafter.

FIG. 1 is a top perspective view of an automatic juicer apparatus according one embodiment of the present disclosure;

FIG. 2 is a cross-sectional side elevational view of the automatic juicer apparatus taken at section line A-A in FIG. 1, and illustrating an advancement of an object for juicing, such as a half fruit, through the automatic juicer apparatus;

FIG. 3 is an exploded top perspective view of the automatic juicer apparatus shown in FIG. 1;

FIG. 4 is a top perspective view of an automatic juicer apparatus according to another embodiment of the disclosure, and illustrating an advancement of an object for juicing, such as a half fruit, through the automatic juicer apparatus;

FIG. 5 is a cross-sectional side elevational view of the automatic juicer apparatus taken at section line B-B in FIG. 4, and illustrating an advancement of an object for juicing, such as a half fruit, through the automatic juicer apparatus;

FIG. 6 is a cross-sectional front elevational view of the automatic juicer apparatus taken at section line C-C in FIG. 4, and illustrating an installation of a motor within a base of the automatic juicer apparatus;

FIG. 7 is an exploded top perspective view of the automatic juicer apparatus shown in FIG. 4;

FIG. 8 is a top perspective view of an automatic juicer apparatus according to yet another embodiment of the present disclosure;

FIG. 9 is a fragmentary enlarged cross-sectional side elevational view of the automatic juicer apparatus taken at section line D-D in FIG. 8;

FIG. 10 is an exploded top perspective view of an automatic juicer apparatus according to yet a further embodiment of the present disclosure;

FIG. 11 is a flow diagram illustrating a method for juicing using the automatic juicer apparatus of FIGS. 1-10.

### DETAILED DESCRIPTION

The following description is merely exemplary in nature and is not intended to limit the present disclosure, application, or uses. In respect of the methods disclosed, the order of the steps presented is exemplary in nature, and thus, is not necessary or critical unless otherwise disclosed.

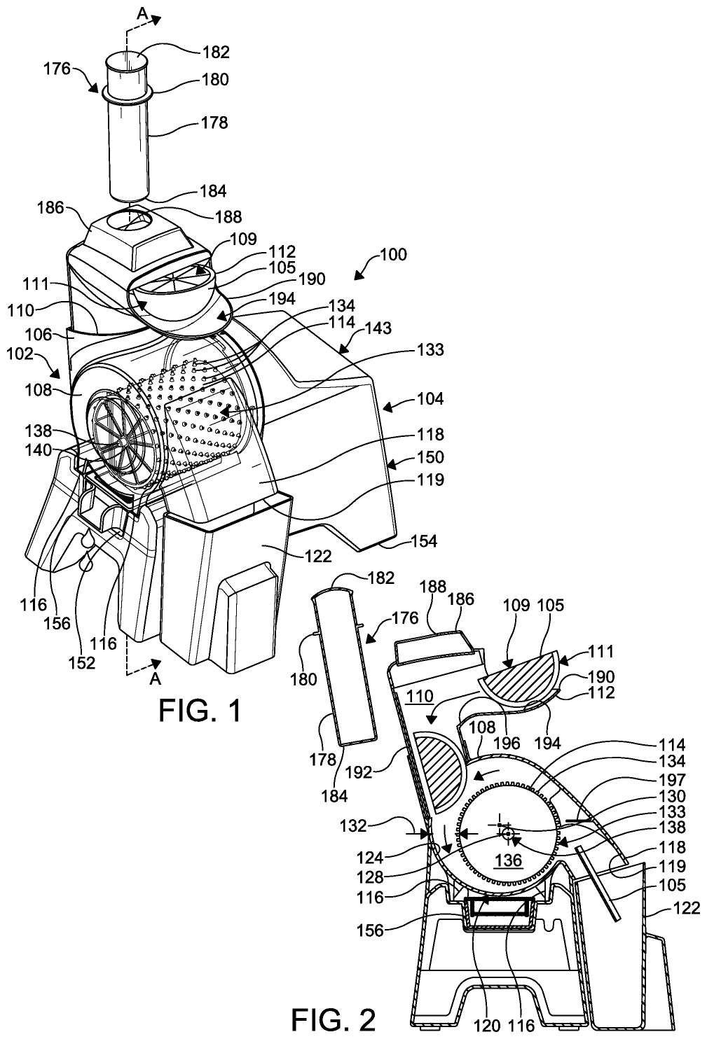

An automatic juicer apparatus 100, 100′, 100″, 100′″ according to various embodiments of the disclosure is shown in FIGS. 1-10. The automatic juicer apparatus 100, 100′, 100″, 100′″ is configured to automatically prepare “fresh squeezed” juices without the need for manual intervention or equipment such reamers. The automatic juicer apparatus 100, 100′, 100″, 100′″ is also specially designed for household use and has a size suitable for placement of the automatic juicer apparatus 100, 100′, 100″, 100′″ on a surface (not shown) such as a countertop or table in a home or residential setting.

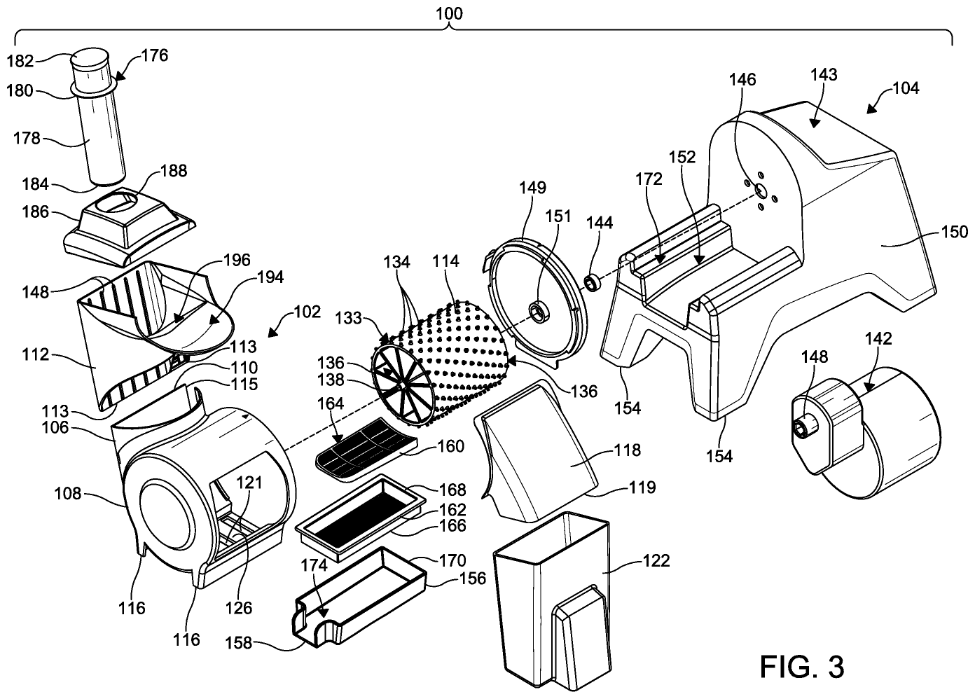

With reference to FIGS. 1-3, the automatic juicer apparatus 100 may have a main body 102 and a base 104. The base 104 is configured to support the main body 102 on the surface such as the countertop or table. The main body 102 may also be removably coupled with the base 104, for example, as shown in FIG. 3. Advantageously, the main body 102 and base 104 permit for an easy disassembly of the automatic juicer apparatus 100, which allows the automatic juicer apparatus 100 to be stored or cleaned when not being used.

Although the automatic juicer apparatus 100 is shown in FIGS. 1-2, 4-6, and 8-9 as juicing citrus fruit such as oranges, and more particularly pre-cut half fruit 105, it should be appreciated that the juicing of other types of fruits and vegetables, either whole or in other cut configurations, is contemplated for the automatic juicer apparatus 100 and considered to be within the scope of the present disclosure.

In most particular examples, the pre-cut half fruit 105 is processing in the automatic juicer apparatus 100. The pre-cut half fruit 105 may have a cut surface 109 and an uncut surface 111, for example, as shown in FIGS. 1-2. It should be appreciated that the pre-cut half fruit 105 may also be placed in the intake portion 106 with a specific predetermined orientation that has been deemed most advantageous for the juicing process, and as described further herein.

With reference to FIGS. 1-3, the main body 102 of the automatic juicer apparatus 100 may have an intake portion 106 and a roller housing 108. The intake portion 106 may be in the form of an open chute with an intake aperture 110, for example. The intake portion 106 and the associated intake aperture 110 are sized and configured to receive objects to be juiced, and more particularly the pre-cut half fruit 105 as described further herein.

In use, the intake portion 106 guides the half fruit 105 into the roller housing 108 while maintaining the orientation so that the half fruit 105 may be properly juiced. More specifically, an interior of the intake portion 106 may be configured to have a width that is approximately the same as a width of the half fruit 105. Advantageously, the width of the intake portion 106 together with the predetermined orientation of the cut surface 109 against the interior of the intake portion 106 militates against the half fruit 105 turning or rotating undesirably before entering the roller housing 108.

The half fruit 105, upon entering the roller housing 108, is compressed between the roller housing 108 and the roller 114, as described further herein, which in turn causes a juicing of the half fruit 105.

The intake portion 106 of the main body 102 may further have a receiving portion 112, for example, as shown in FIGS. 1-3. The receiving portion 112 may be specially configured to receive and orient the cut half fruit 105 into the predetermined orientation within the intake portion 106 of the roller housing 108.

The receiving portion 112 may be selectively removably coupled to the intake portion 106, for example, as shown in FIG. 3, and described further hereinbelow. In a particular example, as illustrated in FIG. 2 and described further hereinbelow, the receiving portion 112 may be generally L-shaped in cross-section and configured to be received by the intake aperture 110 of the intake portion 106. Other suitable configurations and orientations for the receiving portion 112 of the main body 102 may also be employed within the scope of the present disclosure.

The receiving portion 112 may also have an outwardly extending handle 113 disposed at a side thereof, as shown in FIG. 3, which extends through a corresponding slot 115 formed in a side of the intake portion 106 where the intake portion 106 is receiving the receiving portion 112. Locking mechanisms for selectively locking the handle 113 in place along the slot 115, including mechanical fasteners, may also be employed. It should be appreciated that the handle 113 permits for a simple manual adjustment of a height of the receiving portion 112 relative to the base 104.

The roller housing 108 of the present disclosure has a hollow interior and is configured to receive a roller 114, and to permit for a rotation of the roller 114 in operation. As described further herein, and without being bound by any particular theory, it is believed that the predetermined orientation of the half fruit 105 that facilitates the juicing operation is one in which the cut surface 109 of the half fruit 105 faces away from the roller 114 and toward inner surfaces of the roller housing 108. However, a skilled artisan may also adopt other suitable predetermined orientations, depending on the structure of the apparatus 100, within the scope of the present disclosure.

The roller housing 108 may have a generally cylindrical shape, for example, in order to accommodate for a similarly shaped roller 114. The roller housing 108 may also be formed from a rigid material such as thermoplastic, metal, or glass. In particular examples, the material of the roller housing 108 is transparent or translucent, for example, as shown in FIGS. 1-3, and permits for the viewing of the hollow interior of the roller housing 108 in operation. Other suitable shapes, configurations, and materials for the roller housing 108 may also be employed, as desired.

The roller housing 108 may further have a pair of feet 116, for example, as shown in FIGS. 1-3. The pair of feet 116 may be received by, and rest upon, the base 104 upon assembly. Advantageously, the pair of feet 116 allow the main body 102 to be disposed on the base 104 in a raised position above a surface of the base 104. The feet 116 may be provided with a non-slip or rubberized coating, for example, to minimize any slippage relative to the base 104 when in position. Any suitable size and shape for the feet 116 may also be used within the scope of the disclosure.

With continued reference to FIGS. 1-3, the roller housing 108 may also have a remains output portion 118 and a juice output portion 120 (shown in FIG. 3). Each of the remains output portion 118 and the juice output portion 120 may define openings in the roller housing 108 through which processed remains of the half fruits 105 are directed in operation. For example, the remains output portion 118 may be located at a side of the roller housing 108 and disposed opposite a location of the intake portion 106. The remains output portion 118 may have an elongate opening 119 that is configured to receive the half fruits 105 following the juicing operation, including the remaining peel or rind of the half fruits 105. The remains output portion 118 may also be removably attached to the roller housing 108, so as to permit for an easier cleaning in use.

Furthermore, the juice output portion 120 of the roller housing 108 may be disposed at a bottom of the roller housing 108. The juice output portion 120 may have at least one drain opening 121 (shown in FIG. 3) formed therein through which juice from the half fruit 105 may drain from the roller housing 108 during the juicing operation. As shown in FIG. 3, the drain opening 121 may be in the form of a single slot centrally formed in the juice output portion 120 at the bottom of the roller housing 108, and disposed adjacent the base 104 upon assembly. The juice output portion 120 may also be provided with a plurality of the drain openings, such as holes formed through a bottom-most section of the major interior surface 124, for example, as shown in FIG. 3. However, one skilled in the art may provide any other suitable numbers and shapes for the drain opening 121 within the scope of the disclosure.

It should also be appreciated that the automatic juicer apparatus 100 may further include an external container 122, such as a bowl or upright receptacle, for collecting the fruit remains after the juicing operation. The external container 122 may be disposed adjacent the opening of the remains output portion 118, for example. The remaining peel or rind of the half fruit 105 may pass through the opening of the remains output portion 118 to the external container 122 during the juicing operation for collection and subsequent disposal of the fruit remains. Other suitable means for collection and disposal of the fruit remains following the juicing operation may also be employed, as desired.

As illustrated in FIG. 2, the roller housing 108 has a major interior surface 124. The major interior surface 124 is configured to slidably receive the half fruit 105 during the juicing operation, in which the half fruit 105 is also pressed or squeezed against the major interior surface 124 by the roller 114. The major interior surface 124 may further have a recessed surface 126 that is disposed between the pair of feet 116 at the bottom of the roller housing 108. The recessed surface 126 is spaced apart from the roller 114 where assembled within the roller housing 108.

In a particular example, as shown in FIG. 3, the drain opening 121 of the juice output portion 120 may be formed in the recessed surface 126. The recessed portion 126 may also be oriented at an angle relative to a surface on which the automatic juicer apparatus 100 is disposed (not shown), so as to permit for gravity-assisted flow of the juice from the half fruits 105 toward the drain opening 121 during the juicing operation. Other suitable shapes and orientations for the recessed surface 126 at the bottom of the roller housing 108 may also be selected by a skilled artisan within the scope of the instant disclosure.

As established hereinabove, the automatic juicer apparatus 100 of the present disclosure further includes the roller 114. The roller 114 may be rotatably disposed in the roller housing 108. In particular, and as shown in FIG. 2, the roller 114 may be positioned within the roller housing 108 on an axis of rotation 128 that is offset from a central axis 130 of the roller housing 108 itself. The offsetting of the roller 114 within the roller housing 108 may advantageously create a gap 132 between the roller 114 and the major interior surface 124 of the roller housing 108. The gap 132 has a varying dimension along the surface of the roller 114 and is wider in a feed area of the roller housing 108 than it is in an output area of the roller housing 108. In particular, the gap 132 has a dimension adjacent to the intake portion 106 that is greater than a dimension of the gap 132 adjacent the output portion 118. The greater dimension of the gap 132 adjacent to the intake portion 106 may be particularly advantageous for receiving the half fruits 105 from the intake portion 106 during the juicing operation and pressing or squeezing the cut fruits 105 as they are advanced toward the output portion 118 by a turning of the roller 114.

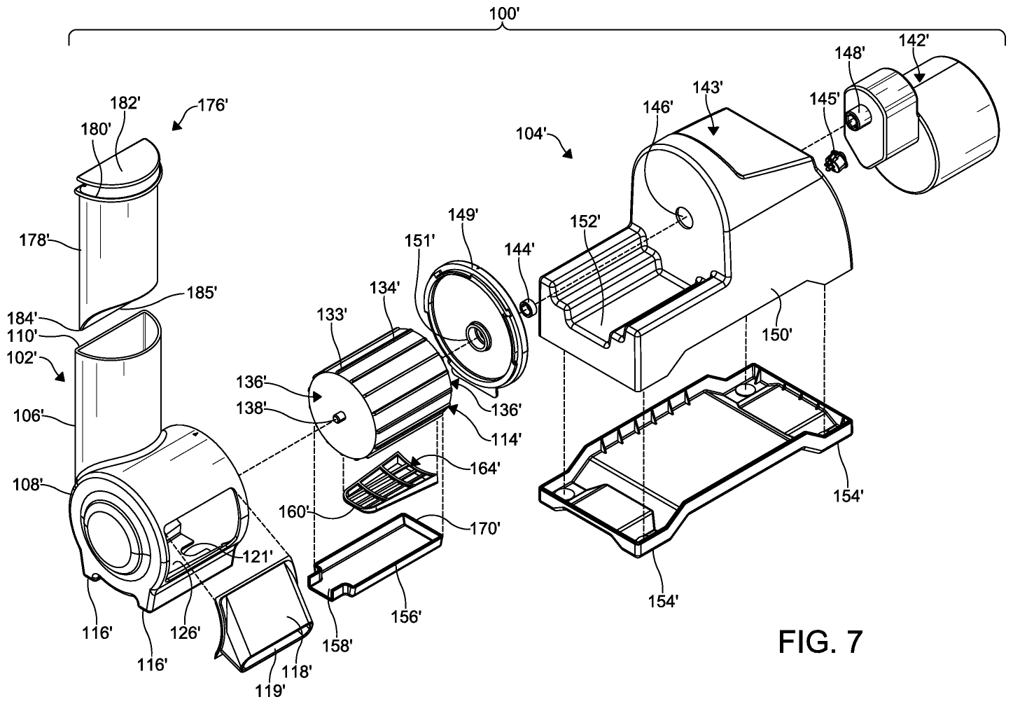

The roller 114 of the present disclosure may have a major curved surface 133. The roller 114 may have a body in the form of a cylinder (shown in FIGS. 1-3), a barrel (shown in FIG. 7), or a sphere (not shown), for example, with the major curve surface 133 circumscribing the body of the roller 114. It should be appreciated that the major curved surface 133 may be continuous, smooth, and uninterrupted, or may have features formed thereon or therein that facilitate a gripping and pressing of the half fruits 105 where the roller 114 is turned.

For example, the major curved surface 133 of the roller 126 may have a plurality of protrusions 134 such as ribs nodules formed thereon. The protrusions 134 may extend across and cover an entirety of the major curved surface 133, for example, the nodules may be arranged in an array and distributed in a regular, repeating pattern across the entirety of the major curved surface 133. The protrusions 134 in the form of ribs may be spaced apart from one another and oriented longitudinally along the major curved surface 133, for example, from one end of the roller 114 to another.

In certain examples, the protrusions 134 on the major curved surface 133 of the roller 114 have a length sufficient to abut the major interior surface 124 of the roller housing 108, or to be spaced apart from, but disposed closely adjacent to, the major interior surface 124. The length of the protrusions 134 may be selected such that, in operation, the half fruit 105 will be firmly pressed in between the major interior surface 124 of the roller housing 108 and the protrusions 134 of the roller 114 by the turning of the roller 114. Other suitable shapes and dimensions for the roller 114, the major curved surface 133, and the protrusions 134 may also be employed, as desired, by one having skill in the art.

Advantageously, a cooperation of the major interior surface 124 of the roller housing 108 and the major curved surface 133 of the roller 114 will automatically juice the half fruit 105 without the need for external force provided by the operator, for example, a reamer or other manual device, where the is turned.

The major interior surface 124 of the roller housing 108 may include a plurality of raised ribs 148 formed therein. The raised ribs 148 define a plurality of channels. The raised ribs 148 and the associated channels may also be formed on an interior surface of at least one of the intake portion 108 and the receiving portion 112, as desired. Advantageously, the ribs 148 may come into contact with the cut surface 109 of the half fruit 105 while it is being processed, thereby facilitating a removal of the juice from the half fruit 105. Further, the channels may direct the juice down the major interior surface 124 to the drain opening 121 so that the juice may exit the main body 102.

With reference to FIG. 3, the roller 114 has a pair of ends 136 between which the major curved surface 133 is disposed. Each of the pair of ends 136 may have a pin 138 formed therein. One of the pins 138 may be disposed in a corresponding aperture 140 formed in a front side of the roller housing 108, for example, as shown in FIG. 1. Another one of the pins 138 may be coupled with a motor 142, for example, via a connector 144 as shown in FIG. 3.

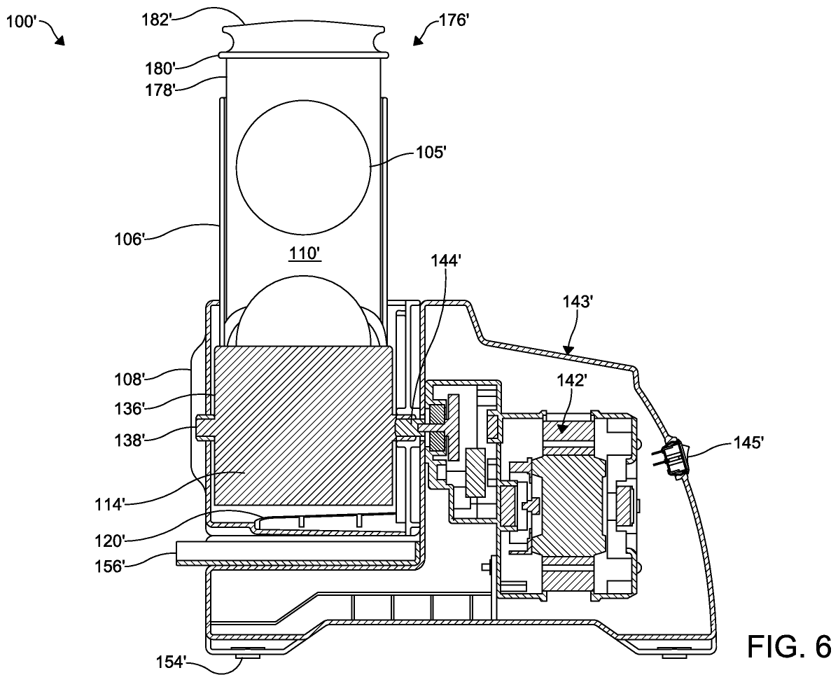

It should be appreciated that the motor 142 is configured to selectively rotate or turn the roller 114 in operation. For example, the motor 142 may be an electric motor that is placed in electrical communication with a power outlet (not shown), and which may be selectively engaged or powered through operation of a switch (shown as 145′ in FIG. 6 and FIG. 7). The motor 142 may be rotated at a single speed or may be provided as a variable speed motor with the operator having the ability to adjust the speed of operation via the switch or other control means. The motor 142 will be sized and have a sufficient power to both advance of the half fruit 105 through the roller housing 108 and sufficiently squeeze or crush the half fruit 105 against the major interior surface 124 of the roller housing 108 as described hereinabove. Other suitable types of the motor 142 and means for controlling the same are contemplated and considered to be within the scope of the disclosure.

In particular, upon assembly of the automatic juicer apparatus 100, the motor 142 may be fixedly or removably disposed within a motor portion 143 of the base 104. As shown in FIG. 3, the base 104 may have an opening 146 configured to receive a drive shaft 148 of the motor 142. The drive shaft 148 may be connected to the roller 114 via one of the pins 138 with the connector 144, as described hereinabove. In operation, the motor 142 turns the drive shaft 148, which in turn rotates the roller 114.

As shown in FIG. 3, the roller housing 108 may further have a side portion 149, which may be removably coupled to the roller housing 108. Advantageously, the removable side portion 149 seals the roller housing 108 during operation but allows the roller 114 to be removed from the roller housing 108 to facilitate cleaning. The removable side portion 149 may further have an aperture 151 formed therein that allows the pin 136 of the roller 114 to be coupled with the drive shaft 148 of the motor 142. Upon assembly of the automatic juicer apparatus 100, the aperture 151 of the removable side portion 149 of the roller housing 108 may be aligned with the opening 146 in the motor portion 143 of the base 104. The connector 144 may likewise be disposed in at least one of the opening 146 and the aperture 151, or disposed adjacent to the same.

It should be appreciated that the base 104, in addition to having the motor portion 143 for containing the motor 142, will also have a support portion 150 and a juice tray support 152. The motor portion 143 may be disposed on the support portion 150. The support portion 150 may be a pedestal for the main body 102, for example, as shown in FIGS. 1 and 2. In particular, the support portion 150 may also have one or more legs 154, which are configured to stabilize and support the automatic juicer apparatus 100 atop the surface such as the countertop or table. Other suitable means for supporting the automatic juicer apparatus 100 may also be selected by the skilled artisan, as desired.

The juice tray support 152 of the base 104 is disposed on the support portion 150 of the base 152 adjacent to the motor portion 143 of the base 104. In particular, the juice tray support 152 may include a recessed platform configured to receive a juice tray 156. The juice tray 156 is configured to receive the fresh squeezed juices from the half fruit 105 upon being processed within the roller housing 108, and to direct the juices away from the automatic juicer apparatus 100. For example, the juice tray 156 may be removably disposed beneath the drain opening 121 of the roller housing 108.

The recessed platform of the juice tray support 152 may also have a shape that generally conforms to a shape of the juice tray 156, so as to securely hold the juice tray 156 during the juicing operation. In alternative examples, the juice tray 156 may be integrally formed with juice tray support 152. However, it should be appreciated that having the juice tray 156 instead be removably disposed in the juice tray support 152 may be preferred, and this arrangement permits for a simple and rapid cleaning of the juice tray 156 in practice.

As further shown in FIGS. 1-3, the juice tray support 152 of the base 104 is also configured to receive at least one grate 160, 162. The at least one grate 160, 162 is disposed beneath the roller housing 18, and between the drain opening 121 of the roller housing 108 and the juice tray 156. The at least one grate 160, 162 may also be removable from the juice tray support 152 so as to permit for cleaning in use.

The juice tray 156 may further have an end with a spout 158 formed therein, for example, as shown in FIGS. 1-3. Advantageously, the spout 158 provides a point of transfer from the juice tray 156 to a glass or another container suitable for storing the juices. The juice, during the juicing operation, may pass through the at least one grate 160, 162 to the juice tray 156, and out of the juice tray 156 to the separate container via the spout 158. The remaining fruit, including excess peel, is advanced or pushed by the roller 114 through the interior of the main body 102 and out of the main body 102 through the output portion 118.

In particular example, as depicted in FIG. 3, the at least one grate 160, 162 may include a coarse grate 160 and a fine grate 162. It should be appreciated that the coarse grate 160 may be provided with larger holes or openings than the fine grate 162. In practice, the coarse grate 160 may be used to capture and militate against relatively large pieces or debris of the pressed half fruit 105 from progressing to the juice tray 156. Likewise, the fine grate 162 may be used to capture and militate against relatively smaller pieces and pulp of the pressed half fruit 105 from progressing to the juice tray 156.

Further, as shown in FIG. 3, it should be appreciated that the coarse grate 160 may have a contoured upper surface 164. The contoured upper surface 164 may have a shape that corresponds closely with an outer surface of the bottom of the roller housing 108. In particular, the contoured upper surface 164 is concave in shape. It should also be understood that any undesirable leakage of the juices from the drain opening 121 to an area outside of the coarse grate 160 may be minimized by the concave shape of the contoured upper surface 164 of the coarse grate 160.

In addition, as also shown in FIG. 3, the fine grate 162 may have at least one wall 166 and an upper flange 168. The at least one wall 166 extends upwardly from the fine grate 162, and the upper flange 168 extends outwardly from an upper edge of the at least one wall 166. The upper flange 168 has a size sufficient to rest upon at least one of an upper edge 170 of the juice tray 156 and a stepped portion 172 of the juice tray support 152 where the automatic juicer apparatus 100 is assembled. In particular, the upper flange 168 serves to suspend the coarse grate 160 and the fine grate 162 above an interior bottom surface 174 of the juice tray 156, such that the juice is permitted to drip into the juice tray 156 during the juicing process.

With continued reference to FIGS. 1-3, the automatic juicer apparatus 100 of the present disclosure may further have a pusher 176. The pusher 176 may have a pusher body 178 and a handle portion 180. The pusher 176 is configured to be selectively disposed in and moved through the intake portion 106 of the main body 102. For example, and as shown in FIGS. 1-2, the pusher body 178 may be a cylinder or rod that is configured to be inserted through the receiving portion 112 and into the intake portion 106. Advantageously, an operator of the automatic juicer apparatus 100 may use the pusher 176 to manually force the half fruits 105 through the intake portion 106 and into the roller housing 108 during the juicing operation.

The pusher body 178 itself has a top 182 and a bottom 184. In certain examples, as shown in FIG. 2, the bottom 184 of the pusher body 178 may be configured to slide into the intake portion 106 and to abut and push against the uncut outer surface 111 of the half fruit 105, to cause the half fruit 105 to move toward the gap 132 between the roller housing 108 and the roller 114.

The handle portion 180 at the top 182 of the pusher 176 may include at least one outwardly extending protrusion or ring that is affixed on or integrally formed with the pusher body 178 adjacent to the top 182 of the pusher body 178, for example, as shown in FIG. 1. The at least one outwardly extending ring may define a convenient a finger or hand-hold for the operator of the automatic juicer apparatus 100. Advantageously, the handle portion 180 may allow the operator to selectively either push the pusher 176 into the intake portion 106 or pull the pusher 176 from the intake portion 106, for example, to load additional half fruits 105 for juicing. Also, the handle portion 180, together with a length of the pusher 176, militates against the pusher 176 being inserted into the intake portion 106 too deeply and undesirably contacting the roller 114 in use.

With further reference to FIGS. 1-3, the automatic juicer apparatus 100 may further have a lid or cover portion 186. The cover portion 186 may be selectively disposed on an open free end of the receiving portion 112. The cover portion 186 may further have a hole 188 formed therein that is configured to receive the pusher 176 for pushing the half fruits 105 toward the gap 132. The hole 188 may have a diameter sufficient to receive a major portion of the pusher body 178, but which militates against undesired movement of handle portion 180 therethrough, thereby preventing the pusher 176 from being dropped into the intake portion 106 by accident during the juicing process.

In particular examples, the receiving portion 112 may have a substantially L-shaped cross-section, for example, as shown in FIG. 2. In this configuration, the receiving portion 112 may have a receiver 190 and a rear wall 192. The receiver 190 may extend outwardly from the receiving portion 112 and have a length configured to accept one of the half fruits 105. The receiver 190 may further have an upwardly-facing, concave receiver surface 194. The concave receiver surface 194 may be configured to receive one of the half fruits 105, in operation, and orient the half fruit into the predetermined orientation to enter the remainder of the receiving portion 112 and subsequently the intake portion 106 of the automatic juicer apparatus 100 for processing.

In further examples, the receiving portion 112 may further have an angled surface 196, which is disposed adjacent to the concave receiver surface 194. The angled surface 196 is specially adapted to tilt or tip the half fruit 105 into a position within the receiving portion 112 such that a cut surface of the half fruit 105 abuts or slides against the rear wall 192 of the receiving portion 112. For example, the angled surface 196 may be arranged on a plane that is between about twenty-five degrees (25°) and about sixty degrees (60°), and more particularly about forty-five degrees (45°) relative to the surface on which the automatic juicer apparatus 100 is disposed. It has been surprisingly found that this is an optimum positioning for the half fruit 105 within the automatic juicer apparatus 100. One of ordinary skill in the art may select suitable angles for the angled surface 196 of the receiving portion 112, as desired.

In addition, and as shown in FIGS. 1 and 3, at least one of the intake portion 106 and the receiving portion 112 may have a portion that is specially shaped so as to orient the half fruit 105 into the optimum position for juicing. For example, at least one of the intake portion 106 and the receiving portion 112 may be shaped such that the cut surface 109 of the half fruit 105 is disposed adjacent the rear wall 192. In particular examples, at least one of the intake portion 106 and the receiving portion 112 may have a substantially D-shaped cross-section, as shown in FIGS. 1 and 3, which likewise forces the generally hemispherical-shaped half fruits 105 into the optimum predetermined orientation or otherwise holds and militates against a movement or rotation of the half fruits 105 from predetermined orientation. Other suitable cross-sectional shapes for at least one of the intake portion 106 and the receiving portion 112 may also be employed by the skilled artisan within the scope of the disclosure.

With reference to FIG. 2, the roller housing 108 may be further provided with a scraper 197. The scraper 197 may be disposed on the major interior surface 124 of the roller housing 108 adjacent to the output portion 118. In particular, the scraper 197 may be disposed directly above the output portion 118, extends inwardly from the major interior surface 124 toward the roller 114, and militates against the processed half fruits 105 being moved away from the output portion 118, e.g., by rotating completing around the roller 114. In this manner, the scraper 197 ensures that the processed half fruits 105 are directed out of the roller housing 108, for example, into the external container 122. One skilled in the art may select other suitable arrangements and configurations for the scraper 197, as desired.

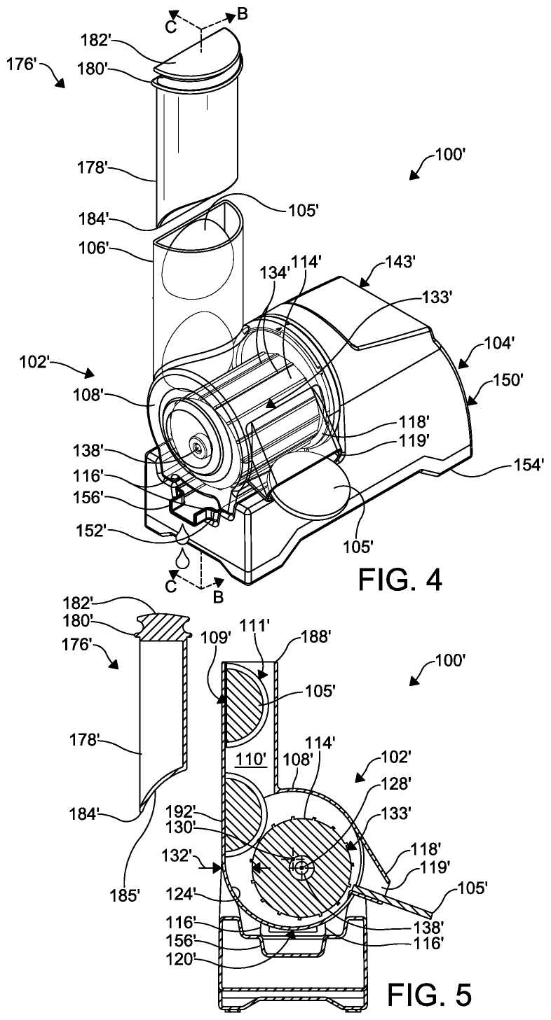

A further embodiment of the automatic juicer apparatus 100′ is shown in FIGS. 4-7. Features in FIGS. 4-7 that are like or related to features in FIGS. 1-3, described hereinabove, are identified with a same reference number and a prime (′) symbol for purpose of clarity. It should be understood that features shown and described with respect to the embodiment of FIGS. 4-7 may also be shared or used in the embodiment of FIGS. 1-3, and vice-versa.

As shown in FIGS. 4-6, the intake portion 106′ of the automatic juicer apparatus 100′ may be provided as an elongate chute. In this configuration, the intake portion 106′ may be used without a separable receiving portion, or may be integrally formed with the receiving portion, and may directly receive the half fruit 105′ for processing.

The elongate chute of the intake portion 106′ may be oriented generally vertically relative to the surface on which the automatic juicer apparatus 100′ is disposed, for example, as shown in FIG. 5, or may be oriented at a slight angle (e.g., up to thirty degrees (30°) off of vertical) relative to the surface, as desired. For example, the angle of the elongate chute may be selected so as to provide for an optimize delivery of the half fruit 105′ to the roller housing 108′ in use.

With continued reference to FIGS. 4-6, the bottom 184′ of the pusher 176′ may have a curved surface 185′. In particular, the curved surface 185′ is generally concave. Advantageously, the curved surface 185′ militates against the pusher 176′ contacting interior structures of the automatic juicer apparatus 100′, and particularly the roller 114′ where the pusher 176′ is used to advance the half fruits 105′ into the roller housing 108′. For example, the curved surface 185′ may confirm generally in shape to a curvature of the roller 114′ and may be permit the pusher 176′ to be inserted into the gap 132′ between the roller 114′ and the major interior surface 124′ of the roller housing 108′.

As shown in FIG. 7, the motor 142′ of the automatic juicer apparatus 100′ may be placed in mechanical communication with the roller 114′ via a variety of mechanical linkages, for example, drive shafts, gears, rotors, chains, pulleys, belts, and the like. The mechanical linkages may also be disposed within the interior of the base 104′, while permitting for the occasional removal and reinstallation of the motor 142′ for cleaning and maintenance. The mechanical linkages may also be selected so as to provide a predetermined rate of rotation and power to the roller 114′ as it is turned or rotated by the motor 142′. One of ordinary skill in the art may select suitable mechanical linkages for the automatic juicer apparatus 100′, as desired.

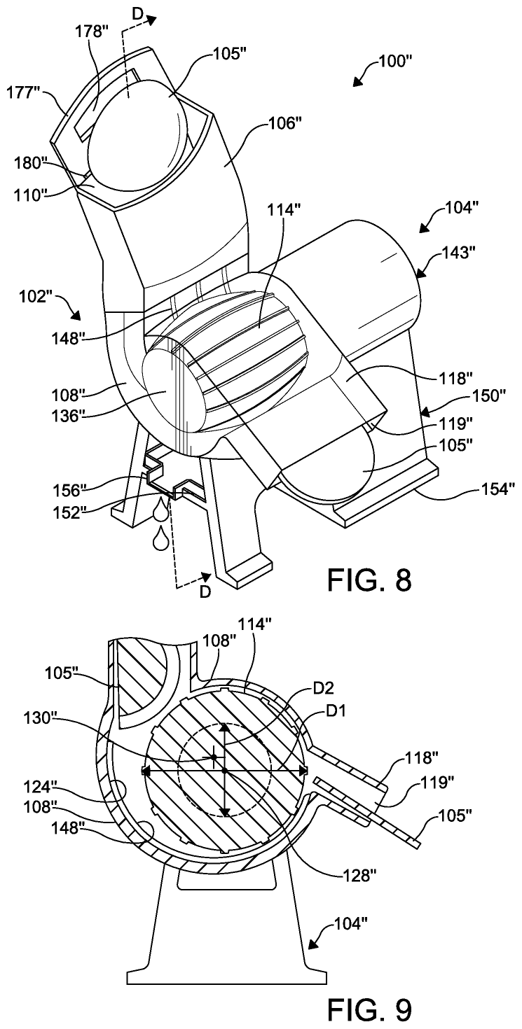

Yet another embodiment of the automatic juicer apparatus 100″ is shown in FIGS. 8-9. Features in FIGS. 8-9 that are like or related to features in FIGS. 1-7, described hereinabove, are identified with a same reference number and a double-prime (″) symbol for purpose of clarity. It should be understood that features shown and described with respect to the embodiment of FIGS. 8-9 may also be shared or used in the embodiments of FIGS. 1-7, and vice-versa.

As shown in FIGS. 8-9, intake portion 106″ may be tilted towards the operator and have a door 177″ instead of the pusher. The door 177″ may be attached by a hinge 180″ to the intake portion 106″, for example. The door 177″ is configured to selectively seal the intake portion 106″, for example, following insertion of the half fruit 105″ into the roller housing 108′ and during the juicing operation. The door 177″ may also have an indent 178″ formed therein, which is configured to receive the half fruit 105″ prior to insertion. Advantageously, the indent of the door 177″ may function to push the half fruit 105″ down into the intake portion 106″ upon a closing of the door 177″.

As shown in FIG. 7, the roller 114″ may further be barrel-shaped. Where barrel-shaped, the roller 114″ may have a diameter D1 at a center of the roller 114″ that is greater than a diameter D2 of each one of the ends 136″. However, as also established further hereinabove, other suitable shapes for the roller 114″ may also be employed.

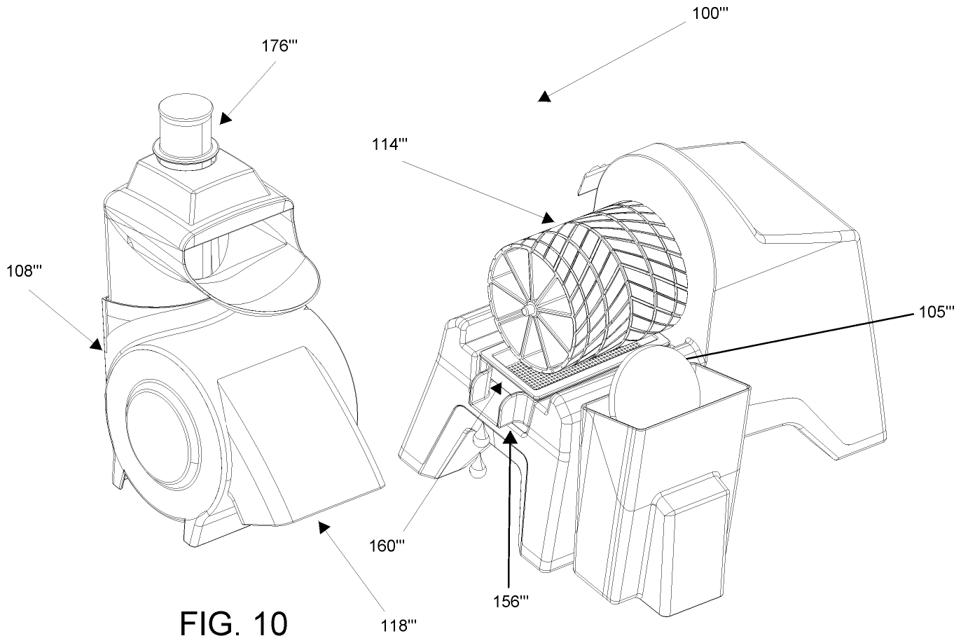

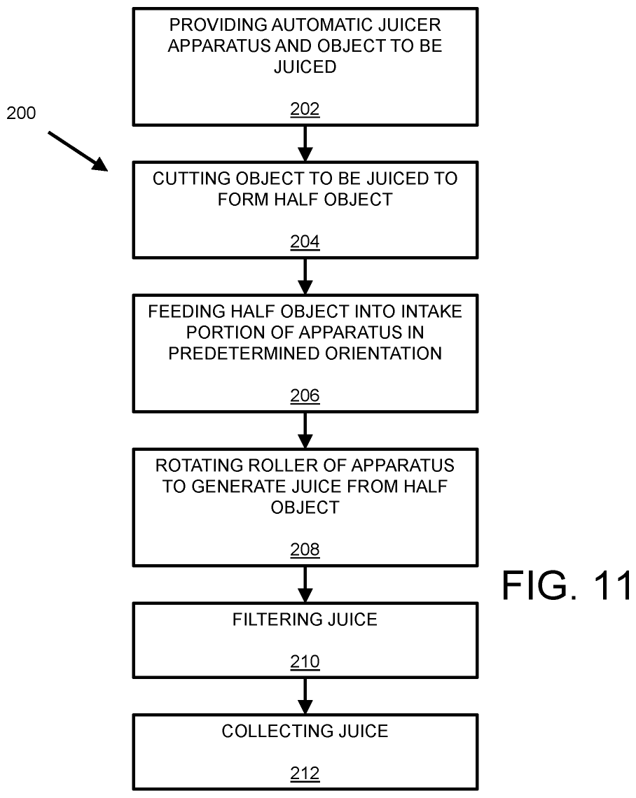

Yet a further embodiment of the automatic juicer apparatus 100′″ is shown in FIG. 10. Features in FIG. 10 that are like or related to features in FIGS. 1-9, described hereinabove, are identified with a same reference number and a triple-prime (′″) symbol for purpose of clarity. It should be understood that features shown and described with respect to the embodiment of FIG. 10 may also be shared or used in the embodiments of FIGS. 1-9, and vice-versa.

As shown in FIG. 10, it should be appreciated that the roller 114′″ of the automatic juicer apparatus 100′″ may be designed specially to grab the half fruit 105′″ in operation. For example, the roller 114′″ may have an outer surface that has a tread pattern, e.g., a “snow tread” type pattern, formed therein. In further examples, the outer surface of the roller 114′″ may be rubberized, with the tread pattern formed in the rubber on the outer surface of the roller 114′″.

In addition, as also shown in FIG. 10, the roller housing 108′″ may be integrated with the filter or grate 160′″, for example, to make for a single unitary once-piece configuration. In further examples, the filter or grate 160′″ may be integrated with the underlying juice tray 156′″. A position of the remains output portion 118′″ may also be selected or optimized, for example, as shown in FIG. 10, with the roller 114′″ and roller housing 108′″ positions being effectively reversed from what is shown in FIGS. 1-9. In addition, as further shown in FIG. 10, the pusher 176′″ may be selected to be longer than what is shown in FIGS. 1-9. Other such design considerations may also be selected by the skilled artisan, as desired.

With reference to FIG. 11, the present disclosure further includes a method 200 for juicing using the automatic juicer apparatus 100, 100′, 100″, 100′″ described hereinabove. The method 200 involves a first step 202 of providing the automatic juicer apparatus 100, 100′, 100″, 100′″ of the present disclosure and an object to be juiced.

In a second step 204, the object to be juiced is cut to form the half object 105, 105′, 105″, 105′″. The half object 105, 105′, 105″, 105′″ has the cut surface 109, 109′, 109″, 109′″ and the uncut surface 111, 111′, 111″, 111′″.

In a third step 206, the half object 105, 105′, 105″, 105′″ is fed through the intake portion 106, 106′, 106″, 106′″ of the automatic juicer apparatus 100, 100′, 100″, 100′″ such that the cut surface 109, 109′, 109″, 109′″ of the half object 105, 105′, 105″, 105″ faces away from the roller 114, 114′, 114″, 114′″ and the uncut surface 111, 111′, 111″, 111′″ abuts the roller 114, 114′, 114″, 114′″.

In a fourth step 208, the roller 114, 114′, 114″, 114′″ is rotated by the motor 142, 142′, 142″, 142′″ to cause the half object 105, 105′, 105″, 105′″ to be pressed against the roller housing 108, 108′, 108″, 108′″ of the main body 102, 102′, 102″, 108′″. Juice is thereby generated from the half object 105, 105′, 105″, 105′″. The rotating of the roller 114, 114′, 114″, 114′″ also causes remains of the half object 105, 105′, 105″, 105′″ to be advanced to the remains output portion 118, 118′, 118″, 118′″ of the main body 102, 102′, 102″, 102′″ for disposal.

In an optional fifth step 210, the juice may be filtered as it flows from the juice output portion 126, 126′, 126″, 126′″ of the roller housing 108, 108′, 108″, 108′″ to the juice tray 156, 156′, 156″, 156′″.

In a sixth step 212, the juice is collected, by way of the juice tray 156, 156′, 156″, 156′″. The juice flows through the juice output portion 126, 126′, 126″, 126′″ of the roller housing 108, 108′, 108″, 108′″ to the juice tray 156, 156′, 156″, 156′″.

Advantageously, the automatic juicer apparatus 100, 100′, 100″, 100′″ and associated method 200 of the present disclosure has been found suitable for consumer household use. The automatic juicer apparatus 100, 100′, 100″, 100′″ and method 200 are efficient, and desirably the automatic juicer apparatus 100, 100′, 100″, 100′″ may be disassembled into a variety of parts and pieces, as detailed hereinabove, to facilitate cleaning and repeated use in the household setting.

While certain representative embodiments and details have been shown for purposes of illustrating the invention, it will be apparent to those skilled in the art that various changes may be made without departing from the scope of the disclosure, which is further described in the following appended claims.

What is claimed is:

1. An automatic juicer apparatus, comprising:
a main body having a roller housing, an intake portion, a juice output portion, and a remains output portion, the intake portion configured to maintain an object to be juiced in a predetermined orientation;
a base on which the main body is removably disposed, the base configured to support the main body on a surface;
a motor disposed in the base; and
a roller disposed in the roller housing of main body and removably coupled to the motor, the roller configured to rotate and press the object in the predetermined orientation against the roller housing to generate and advance juice to the juice output portion and to advance remains of the object to the remains output portion.

2. The automatic juicer apparatus of claim 1, wherein the intake portion is a chute disposed on the roller housing, the chute having an intake aperture configured to receive the object to be juiced.

3. The automatic juicer apparatus of claim 1, wherein the object to be juiced is a half fruit having a cut surface and an uncut surface, and wherein the cut surface is facing away from the roller in the predetermined orientation.

4. The automatic juicer apparatus of claim 3, further comprising a receiving portion removably coupled with the intake portion of the main body, the receiving portion configured to orient the half fruit into the predetermined orientation for juicing.

5. The automatic juicer apparatus of claim 4, wherein at least one of the intake portion and the receiving portion has a substantially D-shaped cross-section that is adapted to one of hold and position the half fruit in the predetermined orientation.

6. The automatic juicer apparatus of claim 4, wherein the receiving portion has a receiver and a rear wall, the receiver extending outwardly from the receiving portion and have a length configured to accept the half fruit.

7. The automatic juicer apparatus of claim 6, wherein the receiver further has an upwardly-facing, concave receiver surface configured to hold the half fruit prior to insertion of the half fruit into the intake portion.

8. The automatic juicer apparatus of claim 7, wherein the receiving portion further has an angled surface disposed adjacent the concave receiver surface, the angled surface configured to orient the half fruit into the predetermined orientation upon being inserted through the receiver portion into the intake portion.

9. The automatic juicer apparatus of claim 4, further comprising a cover portion removably disposed on the receiving portion adjacent to the receiver, the cover portion having a hole formed therethrough.

10. The automatic juicer apparatus of claim 9, further comprising a pusher adapted to position the object to be juiced into the roller housing through the intake portion of the main body, the pusher received by the hole in the cover portion of the receiving portion.

11. The automatic juicer apparatus of claim 1, wherein the roller housing has a central axis and the roller has an axis of rotation, and an axis of rotation for is offset from the central axis.

12. The automatic juicer apparatus of claim 1, wherein a major interior surface of at least one of the roller housing and the intake portion of the main body has a plurality of protrusions.

13. The automatic juicer apparatus of claim 12, wherein the protrusions are ribs that further define channels in the at least one of the roller housing and the intake portion of the main body.

14. The automatic juicer apparatus of claim 1, wherein the roller has a major curved surface with a plurality of protrusions.

15. The automatic juicer apparatus of claim 14, wherein the protrusions are one of an array of nodules and a plurality of ribs disposed on the major curved surface of the roller.

16. The automatic juicer apparatus of claim 1, further comprising a juice tray disposed between the juice output portion of the main body and the base, the base supporting the juice tray, and the juice tray configured to receive the juice from the juice output portion of the roller housing.

17. The automatic juicer apparatus of claim 16, further comprising at least one grate removably disposed between the juice output portion of the roller housing and the juice tray.

18. An automatic juicer apparatus, comprising:
a main body having a roller housing, an intake portion, a juice output portion, a remains output portion, a receiving portion, and a cover portion, the intake portion configured to maintain a half fruit to be juiced in a predetermined orientation, the receiving portion removably coupled with the intake portion of the main body, the receiving portion configured to orient the half fruit into the predetermined orientation for juicing, the cover portion removably disposed on the receiving portion and having a hole formed therethrough;
a base on which the main body is removably disposed, the base configured to support the main body on a surface;
a pusher adapted to position the half fruit to be juiced into the roller housing through the intake portion of the main body, the pusher received by the hole in the cover portion of the receiving portion.
a motor disposed in the base;
a roller disposed in the roller housing of main body and removably coupled to the motor, the roller configured to rotate and press the object in the predetermined orientation against the roller housing to generate juice and to advance remains of the object to the remains output portion;
a juice tray disposed between the juice output portion of the main body and the base, the base supporting the juice tray, and the juice tray configured to receive the juice from the juice output portion of the roller housing;
a coarse grate; and
a fine grate, the coarse grate and the fine grate removably disposed between the juice output portion of the roller housing and the juice tray, the coarse grate disposed adjacent to the juice output portion of the roller housing and the fine grate disposed adjacent to the juice tray.

19. A method of juicing comprising:
providing an automatic juicer apparatus including a main body having a roller housing, an intake portion, a juice output portion, and a remains output portion, the intake portion configured to maintain an object to be juiced in a predetermined orientation, a base on which the main body is removably disposed, the base configured to support the main body on a surface, a motor disposed in the base, a roller disposed in the roller housing of main body and removably coupled to the motor, the roller configured to rotate and press the object in the predetermined orientation against the roller housing to generate and advance juice to the juice output portion and to advance remains of the object to the remains output portion;
cutting the object to be juiced to form a half object, the half object having an uncut surface and a cut surface;
feeding the half object through the intake portion of the automatic juicer apparatus such the cut surface of the half object faces away from the roller and the uncut surface abuts the roller;
rotating the roller, by the motor, to cause the half object to be pressed against the roller housing of the main body, whereby juice is generated from the half object, and to cause remains of the half object to be advanced to the remains output portion of the main body; and
collecting, from the juice output portion, the juice generated from the half object, the juice flowing through the juice output portion of the roller housing to the juice tray.

20. The method of claim 19, further comprising a step of filtering the juice by at least one grate removably disposed between the juice output portion of the roller housing and a juice tray, the juice tray disposed between the juice output portion of the main body and the base, the base supporting the juice tray, and the juice tray configured to receive the juice from the juice output portion of the roller housing.
